(19) United States
(12) Patent Application Publication
(10) Pub. No.: US 2010/0253968 A1
(43) Pub. Date: Oct. 7, 2010

(54) APPROACH FOR DISPLAYING COST DATA FOR LOCKED PRINT DATA AT PRINTING DEVICES

(76) Inventor: Jayasimha Nuggehalli, Cupertino, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/417,846

(22) Filed: Apr. 3, 2009

(51) Int. Cl. G06F 3/12

(52) U.S. Cl. 358/1.15

(57) ABSTRACT

An approach is provided for implementing locked printing on a printing device with a display of cost data. The printing device includes a locked print process that is configured to determine whether locked printing is to be used for print data received at the printing device. Print data designated for locked printing is stored on the printing device. The printing device displays a cost of printing selected print data for one or more printing devices accessible to the printing device. A user has the option of forwarding the selected print data to a printing device accessible to the printing device for printing based on the displayed cost data. This display of cost data can be in response to a request by the user to (a) display cost data, (b) print the selected print data at the printing device, or (c) print selected print data that has an attribute that exceeds a specified threshold.

### RELATED APPLICATION DATA

This application is related to U.S. patent application Ser. No. 12/166,999 (Attorney Docket No. 49986-0667) entitled LOCKED PRINT WITH INTRUDER DETECTION AND MANAGEMENT, filed Jul. 2, 2008; U.S. patent application Ser. No. 12/144,549 (Attorney Docket No. 49986-0665) entitled IMPROVE THE PERFORMANCE OF A LOCKED PRINT ARCHITECTURE, filed Jun. 23, 2008, the contents all of which are incorporated by reference in their entirety for all purposes as if fully set forth herein.

### FIELD OF THE INVENTION

This invention relates generally to locked printing on printing devices, and specifically to displaying cost data for locked print data at printing devices.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Some printing devices are configured with a feature known as “locked printing” to provide control over the printing of electronic documents. When the locked printing feature is enabled for print data that is sent to such a printing device, the printing device stores the print data identified as locked print data, and does not immediately process the print data for printing. A user gains access to the stored print data through an operation panel on the particular printing device to which the user sent the locked print data, i.e., by entering authentication information, which enables the printing device to grant the user access to print data stored on the printing device.

One of the problems with conventional locked printing approaches is that once a user has sent locked print data to a particular printing device, the user generally prints from that particular printing device, without respect to the cost of printing the print data. As such, the user misses an opportunity to save money by sending the print data to a printing device that can print the print data at a lower cost than the printing device to which the user originally sent the print data.

### SUMMARY

An approach is provided for implementing locked printing on a printing device with a display of cost data for printing print data at one or more printing devices. The printing device includes a locked print process that is configured to examine print data received by the printing device and determine whether locked printing is to be used for the print data. Print data designated for locked printing is stored on the printing device. The printing device also includes a user interface that allows a user to access one or more portions of print data stored on the printing device. This user interface is further configured to display cost data that indicates a cost for printing the one or more portions of print data on each of a set of accessible printing devices, which gives a user the option to select, from the set of accessible printing devices, a printing device to process the one or more portions of print data for printing. The printing device is configured to receive a selection of a printing device from the set of accessible printing devices, and, in response to receiving the selection of a printing device, to cause the one or more portions of print data to be sent to the selected printing device.

Embodiments of the invention include displaying the cost data when the printing device receives a request to print selected print data stored at the printing device, when the printing device receives a request to display cost data for selected print data stored at the printing device, or when the printing device receives a request to print selected print data stored at the printing device only if the print data has one or more attributes that exceed a corresponding specified threshold. Example attributes include, without limitation, the total number of pages represented in the selected print data and the total cost of printing the selected print data at the printing device.

In another aspect of the invention, the printing device comprises a locked print process configured to determine if one or more portions of print data are to be processed as locked print data. In response to determining that the one or more portions of print data are to be processed as locked print data, the locked print process is configured to cause the one or more portions of print data to be stored at the printing device and not immediately processed for printing. The locked print process is also configured to cause to be displayed, on a user interface, cost data that indicates a cost for processing the one or more portions of print data at one or more printing devices, receive user selection data that indicates a selected printing device of the one or more printing devices, and in response to receiving the user selection data, cause the one or more portions of print data to be sent to the selected printing device.

### BRIEF DESCRIPTION OF THE DRAWINGS

In the figures of the accompanying drawings like reference numerals refer to similar elements.

FIG. 1 is a block diagram that depicts an arrangement of network elements on a network for implementing locked printing with a display of cost data on a printing device.

FIG. 2 is a block diagram that depicts an example arrangement of a printing device for implementing locked printing with a display of cost data.

FIG. 3 is a flow diagram depicting an approach for printing locked print data with a display of cost data.

FIGS. 4-6 depict example graphical user interfaces generated at a printing device to allow a user to access print data stored at the printing device.

FIG. 7 depicts an example graphical user interface generated at a printing device to display cost data and to allow selection of a particular printing device for printing selected print data.

FIG. 8 is a flow diagram depicting an approach for calculating and displaying cost data.

FIG. 9 depicts an example graphical user interface generated at a printing device to allow a user to access print data stored at the printing device.

FIG. 10 depicts an example graphical user interface generated at a printing device to display cost data and to allow selection of a particular printing device for printing selected print data.

FIG. 11 is a block diagram that depicts an arrangement for implementing locked printing with a display of cost data with a remote management system.

FIG. 12 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:
I. OVERVIEW
II. LOCKED PRINTING ARCHITECTURE
III. LOCKED PRINTING WITH DISPLAY OF COST DATA
IV. CALCULATION OF COST DATA
   A. DEVICE DISCOVERY
   B. PRINTER INFORMATION DISCOVERY
   C. PRINT COST ESTIMATION
V. IMPLEMENTATION MECHANISMS

### I. Overview

An approach is provided for implementing locked printing on a printing device with a display of cost data for printing one or more portions of print data at one or more printing devices. The printing device includes a locked print process that is configured to examine print data received by the printing device and determine whether locked printing is to be used for the print data. Print data designated for locked printing is stored on the printing device. The printing device also includes a user interface that allows a user to access one or more portions of print data stored on the printing device. This user interface is further configured to display cost data that indicates a cost for printing the one or more portions of print data on each of a set of accessible printing devices, which gives a user the option to select, from the set of accessible printing devices, a printing device to process the one or more portions of print data for printing. The printing device is configured to receive a selection of a printing device from the set of accessible printing devices, and, in response to receiving the selection of a printing device, to cause the one or more portions of print data to be sent to the selected printing device.

Embodiments of the invention include displaying the cost data when the printing device receives a request to print selected print data stored at the printing device, when the printing device receives a request to display cost data for selected print data stored at the printing device, or when the printing device receives a request to print selected print data stored at the printing device only if the print data has one or more attributes that exceed a corresponding specified threshold. Example attributes include, without limitation, the total number of pages represented in the selected print data and the total cost of printing the selected print data at the printing device.

### II. Locked Printing Architecture

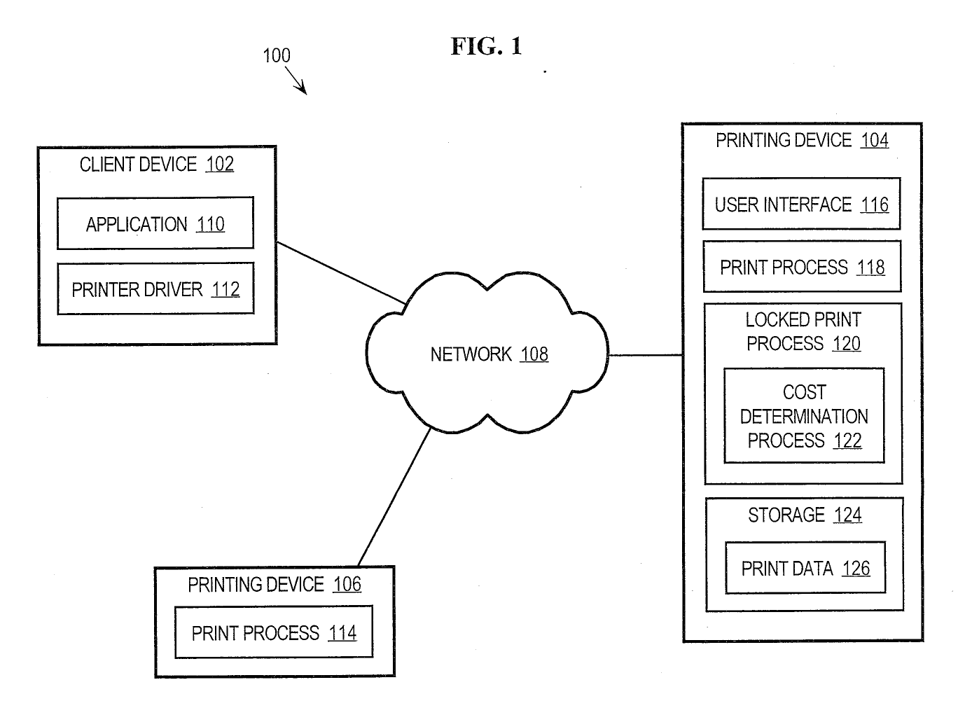

FIG. 1 is a block diagram that depicts an example arrangement 100 for implementing locked printing on a printing device with the capability to display cost data for printing print data at one or more printing devices, according to an embodiment of the invention. Example arrangement 100 includes a client device 102, a printing device 104, and a printing device 106, communicatively coupled via a network 108.

Client device 102 may be implemented by any type of client devices. Example implementations of client device 102 include, without limitation, workstations, personal computers, laptop computers, personal digital assistants (PDAs), cellular telephony devices and any type of mobile devices. In the example arrangement depicted in FIG. 1, client device 102 is configured with an application 110 and a printer driver 112. Application 110 may be any type of application process. Examples of application 110 include, without limitation, a word processor, a spreadsheet program, and an email client. Printer driver 112 is configured to provide a user interface for a user to specify that locked printing is to be used to print particular print data, and to specify that the particular print data is to be sent to a particular printing device, i.e., printing device 104. Printer driver 112 is also configured to process data from application 110 and generate print data that is provided to printing device 104 for processing. Thus, application 110 and printer driver 112 operate together to generate and provide print data to the selected printing device. Client device 102 may be configured with other mechanisms, processes, and functionality, depending upon a particular implementation.

Printing device 104 and printing device 106 may be implemented by any type of device that is capable of processing print data received from client device 102 and generate printed versions of electronic documents reflected in the print data. In example arrangement 100, printing device 104 includes user interface 116, print process 118, locked print process 120, cost determination process 122, storage 124, and print data 126 stored at storage 124. Printing device 104 may be configured with other mechanisms, processes and functionality, depending upon a particular implementation, and the approach described herein for configuring locked printing on a printing device is not limited to any type of printing device. For example, printing device 104 may be a multi-function peripheral (MFP) that includes any combination of printing, copying, facsimile and scanning capability, etc. In example arrangement 100, printing device 106 includes print process 114, but may be configured in a manner similar to printing device 104.

User interface 116 may be any mechanism and/or medium that provides for the exchange of information between a user and printing device 104. Examples of user interface 116 include, without limitation, a control panel with a display and keypad or keyboard, a cathode ray tube (CRT), a liquid crystal display (LCD), a keyboard, touchpad, mouse, trackball, a microphone and speakers, and any combination thereof. Printing device 104 may be configured to display information on user interface 116 in any number of languages, depending upon a particular implementation.

Print process 114 and print process 118 may each be implemented by one or more processes for processing print data received from client device 102 and for generating a printed version of an electronic document reflected in the print data. Locked print process 120 may be implemented by one or more processes configured to provide locked print services, to verify authentication data, and to display information through user interface 116, as described in more detail hereinafter. Print process 118 and locked print process 120 may be implemented as resident processes on printing device 104. Alternatively, print process 118 and locked print process 120 may be made available to printing device 104 on a removable media or may be implemented at a remote location with respect to printing device 104. In a similar manner, print process 114 may be implemented as a resident process on printing device 106, or may be made available to printing device 106 on a removable media or may be implemented at a remote location with respect to printing device 104.

In example arrangement 100, locked print process 120 includes cost determination process 122. Cost determination process 122 maintains a information on printing devices accessible to printing device 104, i.e., printing device 104, and printing device 106, including the respective cost for printing print data at each accessible printing device. The information in cost determination process 122 may be displayed to a user through user interface 116, or by any other means. Cost determination process 122 may be implemented by one or more processes resident on printing device 104 that are configured to maintain information on the cost of printing print data at one or more printing devices. Alternatively, cost determination process 122 may be implemented independently from locked print process 120, or may be made available to printing device 104 on a removable media or may be implemented at a remote location with respect to printing device 104.

Storage 124 may be implemented by any type of storage, including volatile and non-volatile storage. Examples of storage 124 include, without limitation, random access memory (RAM) and one or more disks.

Print process 114, user interface 116, print process 118, locked print process 120, cost determination process 122, and storage 124 may be implemented in hardware, software, or any combination of hardware or software, depending upon a particular implementation.

Network 108 may be implemented with any type of medium and/or mechanism that facilitates the wireless exchange of information between client device 102, printing device 104, and printing device 106. Furthermore, network 108 may use any type of communications protocol and may be secured or unsecured, depending upon the requirements of a particular application.

III. Locked Printing with Display of Cost Data

The approach described here for implementing locked printing on a printing device with a display of cost data for printing print data at one or more printing devices allows a user to consider the relative cost of printing at the one or more printing devices. For example, a user at client device 102 of FIG. 1 uses application 110 to create printable content and, through printer driver 112, sends the print data corresponding to the printable content as locked print data to printing device 104, through network 108. Because the print data is locked print data, locked print process 120 causes the print data to be stored at storage 124 without causing the print data to be immediately processed for printing.

In order to access print data 126, which is stored at storage 124 as a result of being designated as locked print data, the user inputs authentication information into user interface 116 for verification. If the authentication data is successfully verified, then the user gains access to print data 126, which print data may include one or more print jobs. Because print data 126 is stored on printing device 104, the user generally prints the print data at printing device 104, despite the fact that the printing cost per page of printing device 104 is possibly higher than the printing cost per page of printing device 106, which is accessible to printing device 104 through network 108. Information about the cost of printing a document at several different computers can influence a user's decision of where to process the print data for printing. For example, if a first printing device has a printing cost per page of $0.05, then it would cost $50 to print 1000 pages at the first printing device, and if a second printing device has a printing cost per page of $0.06, then it would cost $60 to print 1000 pages at the second printing device. If a user has originally sent 1000 pages to the second printing device, and then finds out that it is $10 less expensive to print the 1000 pages at the first printing device, the user will likely send the print data including 1000 pages to the first printing device to process for printing.

Therefore, using cost determination process 122, locked print process 120 displays to the user, through user interface 116, the cost of processing print data 126 for printing on each of the printing devices accessible over network 108, i.e., printing device 104 and printing device 106. The user then has the option to request that print data 126 be processed for printing at any one of the accessible printing devices. Although only two printing devices are depicted in FIG. 1, the approach is applicable to any number of printing devices. If the relative cost of printing print data 126 at printing device 106 is less than the cost of printing print data 126 at printing device 104, then the user may choose to transfer print data 126 to printing device 106 for printing. If the user chooses to process print data 126 for printing at printing device 106, then printing device 104 transfers the print data over network 108 to printing device 106 and printing device 106 immediately processes the transferred print data for printing through print process 114. Alternatively, the user has the option to process print data 126 at printing device 104.

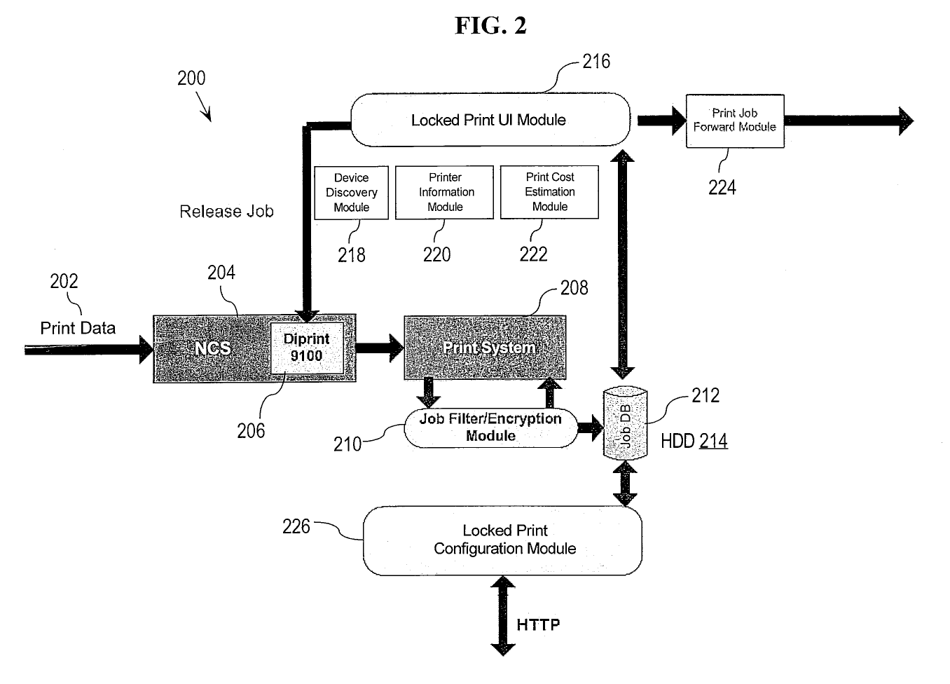

FIG. 2 is a block diagram that depicts an example arrangement of a printing device 200 for implementing locked printing with a display of cost data for printing print data at one or more printing devices, according to an embodiment of the invention. Printing device 200 receives print data 202 through Network Control Service (NCS) 204. NCS 204 runs one or more services to accept print data 202, e.g., Diprint process 206, which is a socket listening on port 9100. NCS 204 optionally runs other services to accept print data 202, e.g., File Transfer Protocol (FTP), Line Printer Remote protocol (LPR), and direct connections to the printing device such as parallel ports and Universal Serial Bus (USB) ports, etc.

NCS 204 transfers print data 202 to Print System 208, which includes a Page Description Language (PDL) Interpreter to interpret PDL data embedded in print data 202. This interpreter processes languages such as Printer Job Language (PJL), PostScript (PS), Printer Control Language (PCL) 5 and 6, and Refined Printing Command Stream (RPCS), etc. Print System 208 transfers print data 202 to Job Filter Module 210, which identifies whether the print data is locked print data or normal print data. Print data may be identified as locked print data, for example, by containing a locked print command. In this embodiment of the invention, if print data 202 is normal print data, then Job Filter Module 210 returns print data 202 to Print System 208, which immediately processes print data 202 for printing on printing device 200. However, if print data 202 is locked print data, print data 202 is marked as normal print data, and stored on hard disk drive (HDD) 214 at Job DB 212. Print data 202 is stored at HDD 214 as normal print data to facilitate printing the stored print data upon request from a user. Alternatively, print data 202 may be stored as locked print data at HDD 214, and the designation of locked print data may be removed upon a request to process print data 202 for printing. Information about print data 202 is also stored in a database at Job DB 212, i.e., the job name, username, and password associated with print data 202, the number of pages included in print data 202, how many times print data 202 has been processed for printing after the print data was stored on hard disk drive 214, etc. Once locked print data is stored on hard disk drive 214, a user may access this print data through Locked Print User Interface (UI) Module 216.

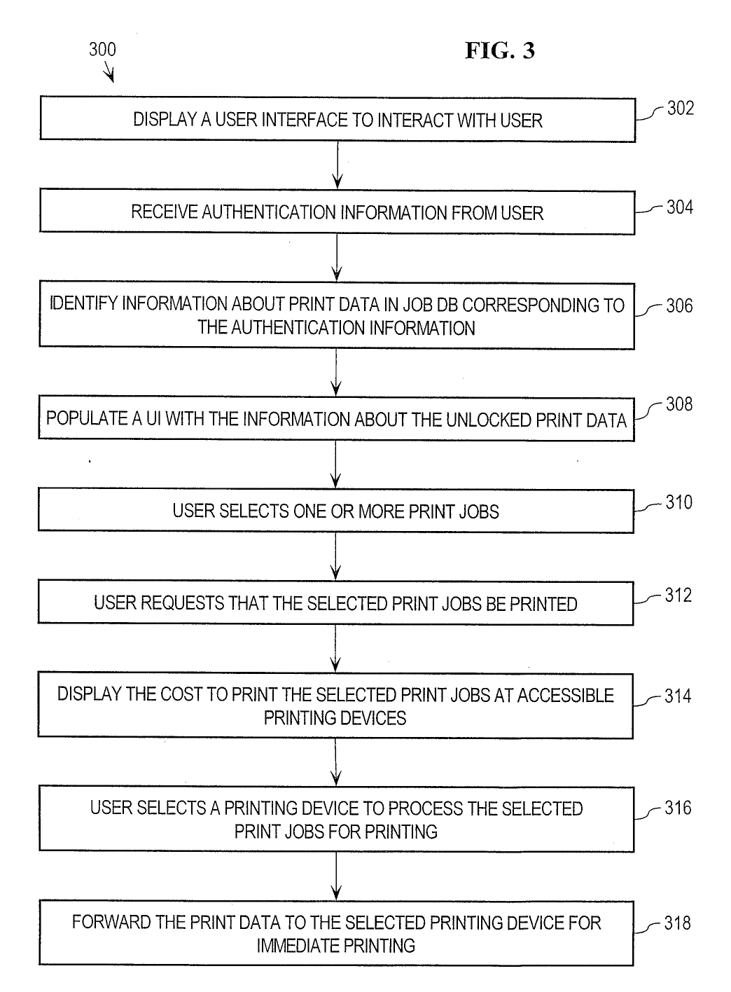

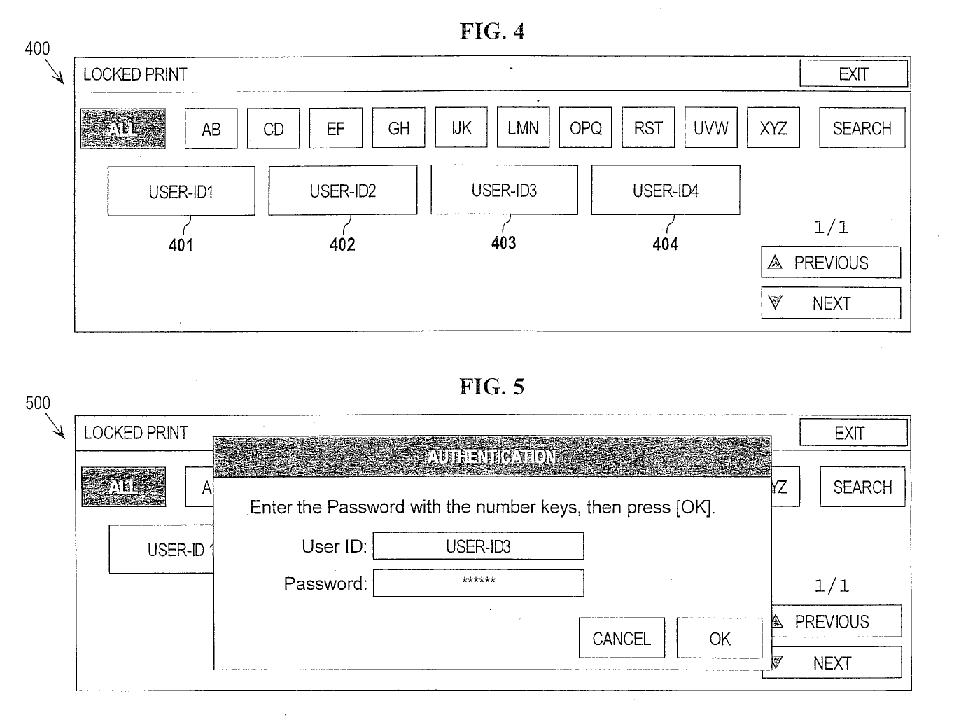

Flow diagram 300 of FIG. 3 illustrates an example process of printing locked print data with a display of cost data, according to one embodiment of the invention. At step 302, a graphical user interface is displayed to interact with users. For example, Locked Print UI Module 216 displays a graphical user interface populated with data from Job DB 212 to interact with users. At step 304, authentication information is received from the user, e.g., Locked Print UI Module 216 receives authentication information, such as a username and password, from a user through the displayed graphical user interface. An example of a graphical user interface displayed by Locked Print UI Module 216 is graphical user interface 400 of FIG. 4, which has a series of buttons 401-404, each button displaying a username found in Job DB 212. A user may select one of the series of buttons 401-404 to submit the corresponding username to Locked Print UI Module 216. In this example, if the user selects button 402, signifying “USER-ID3” as the username, then Locked Print UI Module 216 displays a graphical user interface requesting a password, as illustrated by graphical user interface 500 of FIG. 5. In the alternative, Locked Print UI Module 216 may display a graphical user interface that requests that the user type in both a username and a password. Accessing locked print data by a user may be implemented in various ways within the embodiments of this invention.

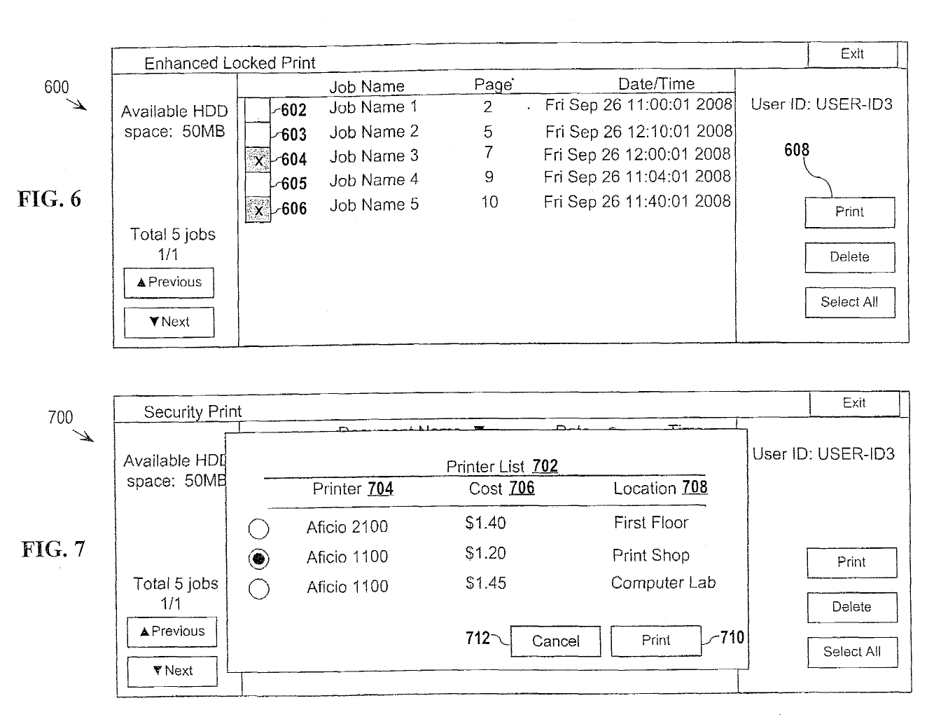

At step 306, information about print data corresponding to the authentication information is identified, and at step 308, a graphical user interface is populated with this information. For example, once a user has been authenticated by Locked Print UI Module 216, Locked Print UI Module 216 identifies information about print data, stored on hard disk drive 214, that is associated with the authentication information. The print data associated with the authentication data of the user is considered “unlocked.” Then, Locked Print UI Module 216 populates a graphical user interface with the information about the print data unlocked by the user, and thereby grants the user access to the unlocked print data. Graphical user interface 600 of FIG. 6 is an example of a graphical user interface that displays the print jobs in Job DB 212 associated with the username “USER-ID3” and the password that Locked Print UI Module 216 received from the user at graphical user interface 500 (FIG. 5). Once a user has access to unlocked print data, the user may request that printing device 200 process any portion of the unlocked print data for printing. In step 310, the user selects one or more print jobs to be processed. For example, the user has the ability to select one or more of the unlocked print jobs by selecting one or more of buttons 602-606 via graphical user interface 600 of FIG. 6. In the example illustrated by FIG. 6, the user has selected buttons 604 and 606 corresponding to print jobs named “Job Name 3” and “Job Name 5.” In step 312, the user selects an action to be performed on the selected print jobs, e.g., processing the selected print jobs for printing. In the example of FIG. 6, the user has the option of requesting that the selected print data associated with buttons 604 and 606 be printed by pressing print button 608, either electronically or physically.

In step 314, when a user selects one or more print jobs and requests that the print data associated with the selected print jobs be processed for printing, the cost to print the selected print jobs at accessible printing devices is displayed. For example, upon a user requesting that selected print jobs be processed for printing, Locked Print UI Module 216 displays the cost to print the selected print jobs at printing devices accessible to printing device 200 through example graphical user interface 700 of FIG. 7. Graphical user interface 700 displays Printer List 702, which includes the names of accessible printing devices 704, the total cost of printing the selected print data at each respective printing device 706, and the location of each respective printing device 708. In addition to this data, Printer List 702 may also display the total number of electronic documents reflected in the selected print data, the total number of pages reflected in the selected print data, the cost for printing each of the selected print jobs for each of the printing devices if more than one print job is selected for printing, the printing cost per page for each of the printing devices, the speed with which each of the printing devices is capable of printing the selected print data, an indication of whether each of the printing devices can print in color, an indication of a duplex capability of each of the printing devices, the total estimated time for each of the printing devices to print the selected print data, the model of each of the printing devices, etc.

At step 316, a user may select a particular printing device of the displayed printing devices to process the selected print jobs for printing. In the example illustrated by graphical user interface 700, the user has selected, from the printing devices in Printer List 702, the “Aficio 1100” printing device located at the “Print Shop.” The user may then initiate the printing process at the selected printing device, e.g., by pressing print button 710. In this example, the user may also revise the selection of print jobs to be printed, e.g., by pressing cancel button 712 to return to graphical user interface 600. At step 318, once the user has requested that print data be processed for printing at a selected printing device, then the print data is forwarded to the selected printing device for immediate printing. In the example of printing device 200, print data that is to be processed for printing on a printing device other than printing device 200 is forwarded to the selected printing device by Locked Print UI Module 216 using Print Job Forward Module 224. In one embodiment of the invention, Print Job Forward Module 224 makes a socket connection with the selected printing device using the IP address of the selected printing device and an appropriate port number, such as 9100 used by the Diprint process, and writes the selected print data to the socket connection. When the selected printing device receives the selected print data, the selected printing device immediately processes the selected print data for printing in the standard manner of the selected printing device.

If a user selects to process the selected print data for printing at printing device 200, then the step of forwarding the print data to the selected printing device, step 318, includes Locked Print UI Module 216 making a local socket connection to Diprint process 206, and writing the selected print data to the socket connection. NCS 204 receives the selected print data through Diprint process 206 and sends the selected print data to Print System 208, which sends the selected print data to Job Filter Module 210. Because all locked print data stored on hard disk drive 214 is marked as normal print data upon storage, Job Filter Module 210 detects that the selected print data is normal print data and sends the selected print data back to the Print System 208 to be immediately processed for printing.

### IV. Calculation of Cost Data

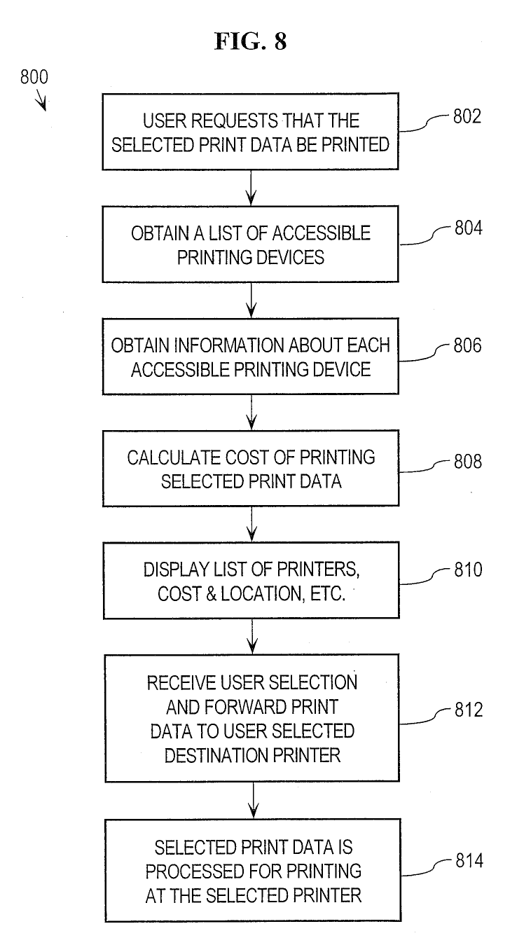

As previously mentioned herein, Locked Print UI Module 216 displays the cost to print the selected print data for printing devices accessible to printing device 200 when the user requests that the selected print data be processed for printing, step 312. This embodiment of the invention is depicted in flow diagram 800 of FIG. 8. The steps of flow diagram 800 are described herein as applying to the configuration of printing device 200, but a printing device need not conform to the configuration of printing device 200 to be within the embodiments of the invention.

At step 802 of FIG. 8, a user requests that the selected print data be processed for printing at a particular printing device. For example, a user requests that printing device 200 process selected print data for printing. At step 804, the particular printing device obtains a list of printing devices accessible to the particular printing device, e.g., printing device 200 obtains a list of printing devices that are accessible to printing device 200 from Device Discovery Module 218. For purposes of explanation, data identifying printing devices to which a particular printing device can transfer print data is referred to as a list of printing devices accessible to the particular printing device, or a list of accessible printing devices. However, such data identifying printing devices to which a particular printing device can transfer print data need not be organized as a list, per se.

At step 806, the particular printing device obtains information about each accessible printing device, i.e., printing cost information and the location of each device. In the example of printing device 200, Printer Information Module 220 provides printing device 200 with information about each printing device in the list of accessible printing device provided by Device Discovery Module 218. At step 808, the particular printing device calculates the cost of printing selected print data at each accessible printing device based at least in part on the information about each accessible printing device. For example, based at least in part on printing cost information for each accessible printing device, Print Cost Estimation Module 222 provides printing device 200 with a calculation of the cost of printing the selected print data for each accessible printing device. For purposes of explanation, Device Discovery Module 218, Printer Information Module 220, and Print Cost Estimation Module 222 are described as separate modules in the explanation and in FIG. 2. However, the functionality attributed to these modules may be implemented by any configuration of modules or included with modules shown and described separately herein. For example, the functionality of Device Discovery Module 218 and Printer Information Module 220 may be implemented by a single module configured to discover both printing devices on a network and information about the discovered printing devices. As a further example, the functionality of Device Discovery Module 218, Printer Information Module 220, and Print Cost Estimation Module 222 may be incorporated into Locked Print UI Module 216.

At step 810, a list of accessible printing devices, cost data associated with each listed printing device, and other information about each listed printing device, e.g., location, is displayed to the user. For example, printing device 200 displays at least the list of accessible printing devices, the cost of printing the selected print data at each accessible printing device, and the location of each accessible printing device on a graphical user interface such as graphical user interface 700 of FIG. 7. The user then has the option to choose one of the accessible printing devices displayed by printing device 200 to process the selected print data for printing. At step 812, the particular printing device receives user selection of a printing device and forwards the selected print data to the user selected destination printer. In the example of FIG. 2, printing device 200 receives the selection of a printing device by the user and forwards the selected print data to the printing device. The selected printing device processes the selected print data for printing, step 814.

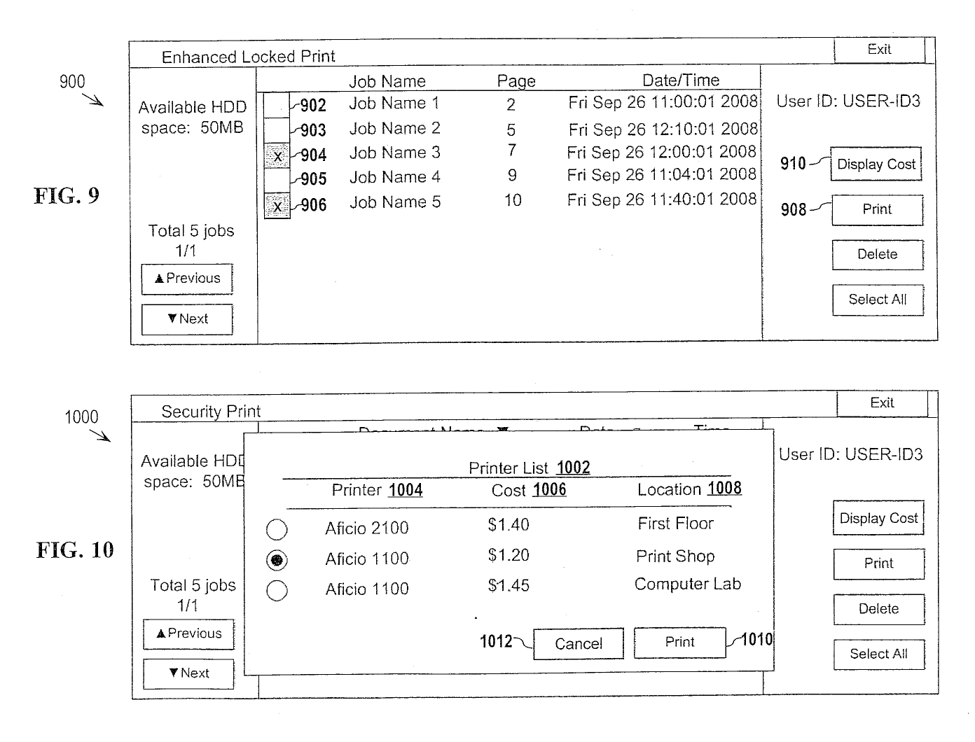

In another embodiment of the invention, Locked Print UI Module 216 gives the user the option to explicitly request a display of cost data for selected print data instead of having cost information automatically displayed in response to the user requesting that selected data be processed for printing. FIG. 9 illustrates graphical user interface 900 that allows a user to access a list of unlocked print jobs. In the example of FIG. 9, graphical user interface 900 includes display cost button 910 in addition to print button 908. If a user selects display cost button 910 after selecting one or more of the unlocked print jobs, e.g., “Job Name 3,” and “Job Name 5,” then Locked Print UI Module 216 displays cost data for printing “Job Name 3” and “Job Name 5” for each of the printing devices accessible to printing device 200. FIG. 10 illustrates an example graphical user interface 1000 showing such cost data.

In yet another embodiment of the invention, Locked Print UI Module 216 displays cost data when a user requests that printing device 200 process selected print data for printing only if one or more attributes of the selected print data exceed a corresponding specified threshold. For example, cost data may be automatically displayed upon a request to print selected print data at a particular printing device when the total number of pages included in the selected print data is over a specified threshold, e.g., 50 pages. If a user selects three print jobs for printing at the particular printing device, and each of the print jobs includes ten pages, then the user has selected print data including a total of 30 pages for printing. Because 30 pages is less than the specified threshold of 50 pages, the print data corresponding to the print jobs selected by the user is immediately processed for printing at the particular printing device, without a display of cost data. However, if the user selects six print jobs for printing at the particular printing device, and each of the print jobs include ten pages, then the user has selected print data including a total of 60 pages for printing. Because 60 pages exceeds the specified threshold of 50 pages, the particular printing device displays cost data to the user to allow the user to select a printing device among a list of accessible printing devices to print the print data corresponding to the selected print jobs. Because the list of accessible printing devices includes the particular printing device, the user has the option of printing at the particular printing device notwithstanding the display of cost data.

As a further example, cost data may be automatically displayed by a particular printing device upon a request to print selected print data if the total cost of printing the selected print data at the particular printing device exceeds a specified threshold, e.g., $5.00. To illustrate, if the printing cost per page of the particular printing device is $0.05 per page, and a user requests that the particular printing device process print data including ten pages for printing, then the total cost of printing the selected print data at the particular printing device is $0.50, which is less than the specified threshold of $5.00. Therefore, the particular printing device processes the selected print data for printing without displaying cost data. In contrast, if the selected print data includes 200 pages, then the total cost of printing the selected print data at the particular printing device is $10.00, which exceeds the specified threshold of $5.00. Therefore, the particular printing device displays cost data to the user to allow the user to select a printing device among a list of accessible printing devices to process the print data for printing.

Locked Print Configuration Module 226 allows an administrator of printing device 200 to specify the configuration of printing device 200, including configuration of locked print parameters. Additionally, an administrator may configure the display of cost data on printing device 200 through Locked Print Configuration Module 226. For example, an administrator may specify that cost data is (a) displayed each time a user requests that printing device 200 process print data for printing, (b) displayed only when the user explicitly requests a display of cost data, or (c) displayed when a user requests that print data be processed for printing only if one or more attributes of the print data exceeds a corresponding specified threshold. An administrator may also choose which attributes are pertinent to the display of cost data and the corresponding specified thresholds, etc, through Locked Print Configuration Module 226. In one embodiment of the invention, the changes made by the administrator through Locked Print Configuration Module 226 apply to all users of printing device 200. Locked Print Configuration Module 226 may include a Web-based user interface provided to allow a user, such as an administrator, to specify configuration data that at least defines one or more functions performed by Locked Print UI Module 216. In the alternative, the configuration of a particular printing device may be specified in other ways. For example, a user may specify the configuration of locked print parameters of a particular printing device by editing a configuration text file and saving the configuration text file to the particular printing device.

### A. Device Discovery

Device Discovery Module 218 maintains a list of printing devices, including Multi-Function Peripherals (MFP) and printers, that are accessible to printing device 200 over a network. In one embodiment of the invention, Device Discovery Module 218 discovers the list of accessible printing devices by using broadcast methods, such as ping sweep, etc. Any method of device discovery may be used within the embodiments of this invention. In another embodiment of the invention, compilation of the list of accessible printing devices by printing device 200 is performed as a background thread, thereby ensuring that the list of accessible printing devices is compiled at the time that Locked Print UI Module 216 displays cost data. In one embodiment of the invention, the list of accessible printing devices excludes those printing devices that are not available for printing and those printing devices that are not authorized to operate with printing device 200. For example, a printing device that is currently processing a large job for printing, that is out of paper, ink, or toner, or that is offline, etc., is not available for printing. As a further example, if printing device 200 is in a high security location, printing device 200 may not be authorized to operate with, or send print data to, printing devices in low security locations.

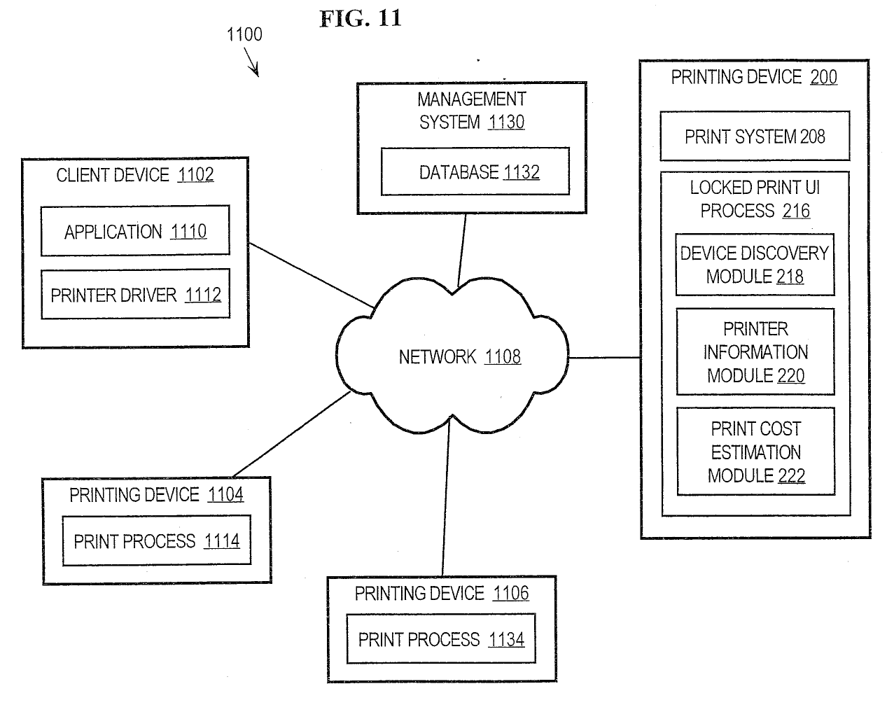

In yet another embodiment of the invention, illustrated by network configuration 1100 of FIG. 11, the list of printing devices accessible to printing device 200 is maintained by a remote management system 1130 having database 1132. Remote management system 1130 may be located on a local network, i.e., an intranet, or may be located outside of the local network, i.e., on the Internet. In this embodiment of the invention, remote management system 1130 performs device discovery to compile a list of printing devices accessible to printing device 200, stored at database 1132, and printing device 200 periodically queries database 1132 for the list. In one embodiment of the invention, remote management system 1130 maintains a single list of printing devices that are located on network 1108. In another embodiment of the invention, remote management system 1130 maintains, for each printing device on network 1108, a list of printing devices on network 1108 to which each particular printing device has the ability and authority to transfer print data.

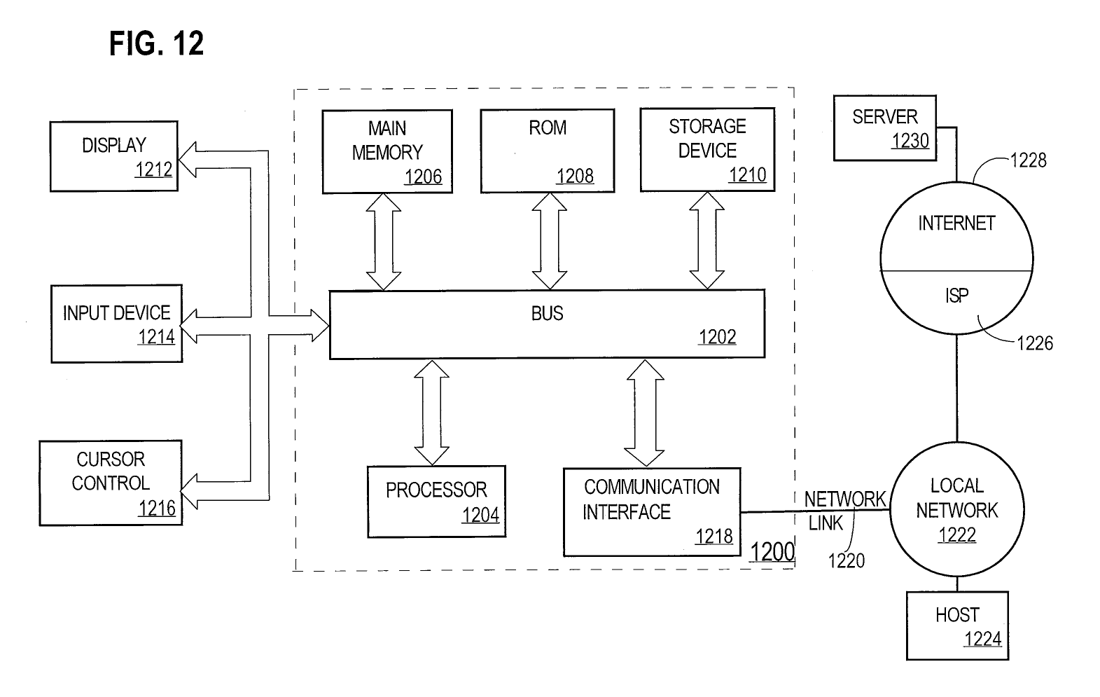

Printing device 200 of FIG. 11 is represented in block form for brevity, and elements not shown have been omitted for purposes of clarity of explanation. Furthermore, printing devices 1104, and 1106 may include elements similar to printing device 200, which are not depicted in FIG. 11 for purposes of brevity. While three printing devices are depicted in FIG. 12, the discussion with respect to FIG. 11 is applicable to any number of printing devices having any combination of elements that implement the embodiments of the invention.

### B. Printer Information Discovery

Printer Information Module 220 of printing device 200 discovers information about each printing device in the list of accessible printing devices. The location and name of each particular printing device is generally stored at the printing device, and, in one embodiment of the invention, Printer Information Module 220 requests this information from each printing device using discovery protocols such as Simple Network Management Protocol (SNMP), or an appropriate Web service, etc. In another embodiment of the invention, Printer Information Module 220 retrieves printer name information from each printing device, wherein the name of each printing device is a unique identifier of the printing device, and uses each printer name to query a database, such as database 1132, for further information about each printing device. In yet another embodiment of the invention, Printer Information Module retrieves all information about the printing devices accessible to printing device 200 from a database 1132 of remote management system 1130, and does not query the individual printing devices for any information.

In embodiments of the invention that involve querying a database, such as database 1132 of remote management system 1130, for information about the individual printing devices on the network, the database contains at least the name and location information for each printing device on the network. In the example of network configuration 1100, remote management system 1130 queries printing devices 200, 1104, and 1106 for information and stores the information on database 1132. Remote management system 1130 may also maintain, for each printing device on network 1108, additional information, e.g., the printing cost per page (CPP), the speed with which the printing device is capable of printing print data, the capability of the printing device to print in color, the duplex capability of the printing device, etc. This additional information about each printing device may be supplied by a human, by the remote management system 1130 itself, or by a service external to network 1108 that maintains printing cost data, etc., for various models of printing devices.

In one embodiment of the invention, the printing CPP for each printing device is an estimate of an average cost of printing a single page at the printing device supplied to the database by an administrator or retrieved from an external service that maintains printing CPP data for various models of printing devices. In another embodiment of the invention, the printing CPP of each printing device is based at least in part on the configuration of each particular printing device. For example, the configuration of a printing device may include a type of toner cartridge, fuser, transfer belt, maintenance kit, ink, drum, etc. In this embodiment of the invention, a database, such as database 1132, may include precise or estimated prices and life spans for the components of each printing device, and either the database or printing device 200 may calculate a corresponding printing CPP from this information. In this embodiment of the invention, Printer Information Module 220 obtains configuration information or printing CPP information from database 1132.

Basing the printing CPP on the particulars of each printing device may increase the precision of the total cost for printing print data displayed to a user. In yet another embodiment of the invention, the printing CPP for a particular printing device is determined using a formula to weight aspects of the current configuration of the particular printing device. For example, the formula for calculating the printing CPP for a particular printing device may weigh the cost of the printing device's toner cartridge and fuser more heavily than the maintenance kit for the particular printing device. Such a formula may be specified and adjusted through Locked Print Configuration Module 226, thus allowing an administrator to adjust the price associated with any particular printing device.

### C. Print Cost Estimation

Print Cost Estimation Module 222 calculates the cost to print the selected print data for each printing device in the list of accessible printing devices. The cost to print the selected print data at a particular printing device may be determined according to the following Eq. 1:

$$C P {P}_{d} * {\sum }_{j = 1}^{n} ( {P}_{j} * {C}_{j} ) \qquad Eq . 1$$

where CPP_{d} is the printing cost per page of a particular printing device, d; n is the total number of printing jobs included in the selected print data; Pⱼ is the number of pages in a particular printing job j; and Cⱼ is the number of copies requested for the particular printing job j. Therefore, Print Cost Estimation Module 222 calculates the total number of pages to be printed in the selected print data and then multiplies the total number of pages by the printing cost per page for a particular printing device to find the total cost of printing the selected print data at the particular printing device.

Print Cost Estimation Module 222 queries Job DB 212 (FIG. 2) to determine each Pⱼ, the number of pages in each particular print job included in the print data selected by the user, and each Cj, the number of copies requested for each particular print job. If Job DB 212 factors the number of copies of each print job into the number of pages of each particular print job in the database, then the cost to print the selected print data at a particular printing device is alternatively determined according to the following Eq. 2:

$$C P {P}_{d} * {\sum }_{j = 1}^{n} {P}_{j} \qquad Eq . 2$$

where CPP_{d} is the printing cost per page of a particular printing device, d; n is the total number of printing jobs in the selected print data; and Pⱼ is the number of pages in a particular printing job j, which already accounts for the number of copies requested for the particular printing job j.

### V. Implementation Mechanisms

The approach described herein for implementing locked printing with a display of cost data may be implemented on any type of computing platform or architecture. According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

FIG. 12 is a block diagram that depicts an example computer system 1200 upon which embodiments of the invention may be implemented. Computer system 1200 includes a bus 1202 or other communication mechanism for communicating information, and a processor 1204 coupled with bus 1202 for processing information. Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic or computer software which, in combination with the computer system, causes or programs computer system 1200 to be a special-purpose machine. According to one embodiment of the invention, those techniques are performed by computer system 1200 in response to processor 1204 executing one or more sequences of one or more instructions contained in main memory 1206. Such instructions may be read into main memory 1206 from another computer-readable medium, such as storage device 1210. Execution of the sequences of instructions contained in main memory 1206 causes processor 1204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 1200, various computer-readable media are involved, for example, in providing instructions to processor 1204 for execution. Such a medium may take many forms, including but not limited to, non-volatile media and volatile media. Non-volatile media includes, for example, optical or magnetic disks, such as storage device 1210. Volatile media includes dynamic memory, such as main memory 1206. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 1204 for execution. For example, the instructions may initially be carried on a magnetic disk of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet” 1228. Local network 1222 and Internet 1228 both use electrical, electromagnetic or optical signals that carry digital data streams.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218. The received code may be executed by processor 1204 as it is received, and/or stored in storage device 1210, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A printing device comprising:
a locked print process configured to:
determine if one or more portions of print data are to be processed as locked print data;
in response to determining that the one or more portions of print data are to be processed as locked print data, cause the one or more portions of print data to be stored at the printing device and not immediately processed for printing;
cause to be displayed, on a user interface, cost data that indicates a cost for processing the one or more portions of print data at one or more printing devices;
receive user selection data that indicates a selected printing device of the one or more printing devices; and
in response to receiving the user selection data, cause the one or more portions of print data to be sent to the selected printing device.

2. The printing device of claim 1, wherein the selected printing device is the printing device.

3. The printing device of claim 1, wherein the selected printing device is a different printing device than the printing device.

4. The printing device of claim 1,
wherein the user interface includes a visual element, selectable by a user, representing an option to display cost data; and
wherein the locked print process is further configured to:
in response to a selection of the visual element representing the option to display cost data, cause to be displayed, on the user interface, the cost data that indicates the cost for processing the one or more portions of print data at one or more printing devices.

5. The printing device of claim 1, wherein the locked print process is further configured to:
receive data indicating a request to process the one or more portions of print data for printing;
in response to receiving the data indicating the request to process the one or more portions of print data for printing, determine whether each attribute of a set of attributes of the one or more portions of print data exceeds a corresponding specified threshold; and
in response to determining that each attribute of the set of attributes of the one or more portions of print data exceeds the corresponding specified threshold, cause to be displayed, on the user interface, the cost data that indicates the cost for processing the one or more portions of print data at the one or more printing devices;
wherein the set of attributes comprises one or more of a total cost for printing the one or more portions of print data, and a total number of pages of the one or more portions of print data.

6. The printing device of claim 1, wherein the locked print process is further configured to cause to be displayed, on the user interface, at least one of:
(a) a total number of electronic documents included in the one or more portions of print data,
(b) a total number of pages of the one or more portions of print data,
(c) a printing cost per page for each printing device of the one or more printing devices,
(d) a total cost of printing the one or more portions of print data at each printing device of the one or more printing devices,
(e) a speed of printing for each printing device of the one or more printing devices,
(f) an indication of a capability of each printing device of the one or more printing devices to print in color,
(e) an indication of a duplex capability of each printing device of the one or more printing devices,
(f) a location of each printing device of the one or more printing devices,
(g) a name of each printing device of the one or more printing devices,
(h) a type of each printing device of the one or more printing devices,
(i) a total estimated time to print the one or more portions of print data at each printing device of the one or more printing devices, and
(j) a cost for printing a particular job of a plurality of jobs included in the one or more portions of print data.

7. The printing device of claim 1, wherein the locked print process is further configured to discover the one or more printing devices and a name and a location for each printing device of the one or more printing devices using a background thread.

8. The printing device of claim 1, wherein the locked print process is further configured to retrieve device capabilities data for the one or more printing devices and the cost data for the one or more printing devices from a device management system.

9. The printing device of claim 1, wherein the locked print process is further configured to retrieve device capabilities data for the one or more printing devices and the cost data for the one or more printing devices from an external service.

10. The printing device of claim 1, wherein the printing device is authorized to operate with the one or more printing devices, and wherein the one or more printing devices are available for printing.

11. The printing device of claim 1,
wherein the cost data that indicates a cost for processing the one or more portions of print data at a particular printing device is determined based on a current configuration of the particular printing device; and
wherein determining the cost data that indicates the cost for processing the one or more portions of print data at the particular printing device includes using a formula to weight aspects of the current configuration of the particular printing device.

12. A computer-implemented method for displaying cost data at a printing device, the computer-implemented method comprising:
determining if one or more portions of print data are to be processed as locked print data;
in response to determining that the one or more portions of print data are to be processed as locked print data, causing the one or more portions of print data to be stored at the printing device and not immediately processed for printing;
causing to be displayed, on a user interface, cost data that indicates a cost for processing the one or more portions of print data at one or more printing devices;
receiving user selection data that indicates a selected printing device of the one or more printing devices; and
in response to receiving the user selection data, causing the one or more portions of print data to be sent to the selected printing device.

13. A computer-readable medium for displaying cost data at a printing device, the computer-readable medium carrying instructions which, when processed by one or more processors, cause:
a locked print process executing on the printing device and:
determining if one or more portions of print data are to be processed as locked print data;
in response to determining that the one or more portions of print data are to be processed as locked print data, causing the one or more portions of print data to be stored at the printing device and not immediately processed for printing;
causing to be displayed, on a user interface, cost data that indicates a cost for processing the one or more portions of print data at one or more printing devices;
receiving user selection data that indicates a selected printing device of the one or more printing devices; and
in response to receiving the user selection data, causing the one or more portions of print data to be sent to the selected printing device.
